(19) United States
(12) Patent Application Publication
(10) Pub. No.: US 2025/0237312 A1
(43) Pub. Date: Jul. 24, 2025

(54) ROTARY MULTI-WAY VALVE

(71) Applicant: DENSO CORPORATION, Kariya-city (JP)

(72) Inventors: Hiroshi OGAWA, Nisshin-city (JP); Motomasa IIZUKA, Nisshin-city (JP); Ryo NOMURA, Kariya-city (JP)

(21) Appl. No.: 19/176,716

(22) Filed: Apr. 11, 2025

Related U.S. Application Data
(63) Continuation of application No. PCT/JP2023/033789, filed on Sep. 15, 2023.

(30) Foreign Application Priority Data
Oct. 13, 2022 (JP) 2022-164846

(51) Int. Cl. F16K 11/085; B60H 1/00; B60L 50/60; H01M 10/613; H01M 10/625; H01M 10/6567; H01M 10/663

(52) U.S. Cl. CPC F16K 11/0856; B60H 1/00485; H01M 10/613; H01M 10/625; H01M 10/6567; H01M 10/663; B60L 50/60; H01M 2220/20

(57) ABSTRACT

A housing has a housing hole shaped in a cylindrical form. A plurality of ports are arranged in an axial direction, a circumferential direction or a radial direction of a housing hole. At least one split rotor is arranged in the housing hole in the axial direction. A communication passage is formed in the at least one split rotor and is configured to switch between a communicating state and a blocking state between a predetermined one of the plurality of ports and another one of the plurality of ports. A shaft is configured to rotate the at least one split rotor around a central axis of the housing hole. A minute gap is formed between the at least one split rotor and an inner wall of the housing hole to enable minute movement of the at least one split rotor in the radial direction.

### CROSS REFERENCE TO RELATED APPLICATIONS

This application is a continuation application of International Patent Application No. PCT/JP2023/033789 filed on Sep. 15, 2023, which designated the U.S. and claims the benefit of priority from Japanese Patent Application No. 2022-164846 filed on Oct. 13, 2022. The entire disclosures of all of the above applications are incorporated herein by reference.

### TECHNICAL FIELD

The present disclosure relates to a rotary multi-way valve and a thermal distribution system having the same.

### BACKGROUND

In an electric vehicle, there are various devices requiring heat absorption or heat release, such as a battery, a drive system, an electrical system and an air conditioning system. To improve energy efficiency, thermal management is performed by circulating cold water and hot water (hereinafter referred to as hot/cold water) in various patterns depending on the situation. By using a multi-way valve, which has a large number of ports and is capable of achieving various flow patterns, as a valve for switching a circulation pattern of the hot/cold water, it becomes possible to simplify the system. In the feasibility of such a multi-way valve, a rotary valve is advantageous. In the rotary valve, a rotor is placed at an inside of a housing which has a hole shaped in a cylindrical form, and the rotor is rotated around a central axis to switch a flow pattern. This rotary valve enables an increase in the number of the flow passages in both axial and radial directions of the cylindrical hole in the housing and allows for arbitrary setting of connections of the flow passages at the inside of the rotor.

### SUMMARY

This section provides a general summary of the disclosure, and is not a comprehensive disclosure of its full scope or all of its features.

According to the present disclosure, there is provided a rotary multi-way valve configured to switch between a communicating state and a blocking state of each of a plurality of fluid flow passages. The rotary multi-way valve includes a housing, a plurality of ports, at least one split rotor, at least one communication passage and a shaft. The housing has a housing hole shaped in a cylindrical form. The plurality of ports are formed in the housing and extend through an outer wall surface and an inner wall surface of the housing. The at least one split rotor is arranged in an axial direction in the housing hole and is configured to rotate relative to the housing. The at least one communication passage is formed in the at least one split rotor and is configured to switch between a communicating state and a blocking state between a predetermined one of the plurality of ports and another one of the plurality of ports. The shaft is configured to rotate the at least one split rotor around a central axis of the housing hole. A minute gap is formed between the at least one split rotor and an inner wall of the housing hole to enable minute movement of the at least one split rotor in the radial direction.

According to the present disclosure, there is also provided a thermal distribution system for an electric vehicle that includes the rotary multi-way valve.

### BRIEF DESCRIPTION OF DRAWINGS

The drawings described herein are for illustrative purposes only of selected embodiments and not all possible implementations, and are not intended to limit the scope of the present disclosure.

FIG. 1 is a side view of a rotary multi-way valve according to a first embodiment.

FIG. 2A is a cross-sectional view taken along line II-II in FIG. 1.

FIG. 2B is an enlarged view of a portion IIB in FIG. 2A.

FIG. 2C is an enlarged view of a portion IIC in FIG. 2A.

FIG. 3A is a view showing only a housing shown in FIG. 2A.

FIG. 3B is a view showing only a split rotor shown in FIG. 2A.

FIG. 3C is a view showing only a shaft shown in FIG. 2A.

FIG. 4A is a cross-sectional view taken along line IV-IV in FIG. 2A.

FIG. 4B is an enlarged view of a portion IVB in FIG. 4A.

FIG. 5A is a cross-sectional view taken along line V-V in FIG. 2A.

FIG. 5B is an enlarged view of a portion VB in FIG. 5A.

FIG. 6 is a side view showing a state where split rotors and the shaft of the rotary multi-way valve of the first embodiment are assembled.

FIG. 7 is an exploded view of the split rotors of the rotary multi-way valve of the first embodiment, showing blocks and plates as viewed in an axial direction.

FIG. 8 is an unfolded view showing the split rotors of the rotary multi-way valve of the first embodiment, as viewed from a radially outer side in a state where the split rotors are unfolded in a circumferential direction.

FIG. 9 is an explanatory diagram for explaining a thermal distribution system according to a second embodiment.

FIG. 10 is a cross-sectional view of a rotary multi-way valve according to a third embodiment, showing a portion corresponding to FIG. 2A.

FIG. 11 is a cross-sectional view taken along line XI-XI in FIG. 10.

FIG. 12 is a cross-sectional view of a rotary multi-way valve according to a fourth embodiment, showing a portion corresponding to FIG. 11.

FIG. 13 is a cross-sectional view taken along line XIII-XIII in FIG. 12.

FIG. 14 is a perspective view of a housing of a rotary multi-way valve according to a fifth embodiment.

FIG. 15 is a perspective view showing a state where split rotors and a shaft of the rotary multi-way valve according to the fifth embodiment are assembled.

### DETAILED DESCRIPTION

In an electric vehicle, there are various devices requiring heat absorption or heat release, such as a battery, a drive system, an electrical system and an air conditioning system. To improve energy efficiency, thermal management is performed by circulating cold water and hot water (hereinafter referred to as hot/cold water) in various patterns depending on the situation. By using a multi-way valve, which has a large number of ports and is capable of achieving various flow patterns, as a valve for switching a circulation pattern of the hot/cold water, it becomes possible to simplify the system. In the feasibility of such a multi-way valve, a rotary valve is advantageous. In the rotary valve, a rotor is placed at an inside of a housing which has a hole shaped in a cylindrical form, and the rotor is rotated around a central axis to switch a flow pattern. This rotary valve enables an increase in the number of the flow passages in both axial and radial directions of the cylindrical hole in the housing and allows for arbitrary setting of connections of the flow passages at the inside of the rotor. Therefore, this rotary valve is advantageous for the feasibility of a large number of ports and a large number of flow passage patterns in the multi-way valve. In contrast, a valve of a disk-type or a valve of a ball-type is disadvantageous for the feasibility of the multi-way valve because it will result in poor space efficiency.

In one previously proposed rotary valve, the housing includes an outer housing and a fixing member, and the rotor is referred to as a valve core. In this rotary valve, a seal member, which is installed to an outer peripheral portion of the rotor, contacts an inner peripheral surface of the fixing member, which forms the housing, to limit leakage of a fluid between flow passages in the inside of the valve.

The inventors of the present application have identified the following issues regarding the structure of the previously proposed rotary valve described above. In the structure of the previously proposed rotary valve, when the number of tiers of flow passages in the axial direction of the cylindrical hole of the housing is increased to form the multi-way valve, a length of the sealing member in the axial direction is also significantly increased. When sliding friction between the seal member and the inner peripheral surface of the housing is significantly increased in response to application of a surface pressure to the seal member and the inner peripheral surface of the housing, a drive force for rotating the rotor is significantly increased. As a result, a size of an actuator, which rotates the rotor, is increased, and electric power required for driving the actuator is also increased.

If the seal member installed to the outer peripheral portion of the rotor is eliminated in the structure of the previously proposed rotary valve, the amount of leakage of the fluid between the flow passages at the inside of the valve is disadvantageously increased. Particularly in the case of the multi-way valve, the cylindricity tolerances of the housing and the rotor become larger, resulting in a further increase in the amount of leakage of the fluid between the flow passages through the resulting gap at the inside of the valve.

According to one aspect of the present disclosure, there is provided a rotary multi-way valve configured to switch between a communicating state and a blocking state of each of a plurality of fluid flow passages. The rotary multi-way valve includes a housing, a plurality of ports, at least one split rotor, at least one communication passage and a shaft. The housing has a housing hole shaped in a cylindrical form. The plurality of ports are formed in the housing and are arranged in an axial direction, a circumferential direction or a radial direction of the housing hole. The plurality of ports extend through an outer wall surface and an inner wall surface of the housing. The at least one split rotor is arranged in the axial direction in the housing hole and is configured to rotate relative to the housing. The at least one communication passage is formed in the at least one split rotor and is configured to switch between a communicating state and a blocking state between a predetermined one of the plurality of ports and another one of the plurality of ports. The shaft is configured to rotate the at least one split rotor around a central axis of the housing hole. A minute gap is formed between the at least one split rotor and an inner wall of the housing hole to enable minute movement of the at least one split rotor in the radial direction.

With the above configuration, the inventors of the present application have adopted a clearance seal structure at the rotary multi-way valve as a result of the extensive study. The clearance seal structure is a structure that reduces a gap between the housing and the rotor to limit leakage of the fluid between the flow passages at the inside of the valve. However, in the rotary multi-way valve, the housing and the rotor are long in the axial direction. Therefore, when the clearance seal structure is used, a new issue arises: the cylindricity tolerances of the rotor and the housing become stricter (i.e., the cylindricity tolerances increase). Accordingly, the inventors of the present application resolved this issue by adopting the structure that allows the minute movement of the at least one split rotor in the radial direction in the case where the clearance seal structure is used. That is, the at least one split rotor self-aligns by conforming to the inner wall of the housing hole. Therefore, this rotary multi-way valve can relax the cylindricity tolerance of the at least one split rotor and the cylindricity tolerance of the housing while minimizing the leakage of the fluid between the flow passages in the inside of the valve. Additionally, due to the clearance seal structure, the minute gap is formed between the split rotors and the inner wall of the housing hole, and thereby reducing the sliding friction between the inner wall of the housing hole and the at least one split rotor. Therefore, the rotary multi-way valve can reduce the drive torque, which is required to rotate the at least one split rotor and the shaft around the central axis.

According to another aspect, there is provided a thermal distribution system for an electric vehicle. The thermal distribution system includes: the rotary multi-way valve described above; a fluid flow passage that is connected to the plurality of ports of the rotary multi-way valve; and a battery, an electric drive device or an air conditioning device which is connected midway along the fluid flow passage. The thermal distribution system is configured to circulate hot water and cold water to one or more required devices at a required timing when the at least one split rotor and the shaft of the rotary multi-way valve are rotated around the central axis of the housing hole and are set to a predetermined position.

Accordingly, the thermal distribution system enables the downsizing of the actuator that drives the shaft of the rotary multi-way valve and the reduction of the electric power required for the operation of the actuator by incorporating the rotary multi-way valve of the present disclosure.

Hereinafter, embodiments of the present disclosure will be described with reference to the drawings. In each of the following embodiments, portions, which are the same or equivalent to each other, will be indicated by the same reference signs, and the description thereof will be omitted.

### First Embodiment

A rotary multi-way valve of the first embodiment is a valve capable of switching between a communicating state and a blocking state of each of a plurality of fluid flow passages. Specifically, the rotary multi-way valve is a so-called ultra-multi-way valve that has a large number of ports and achieves a plurality of flow patterns.

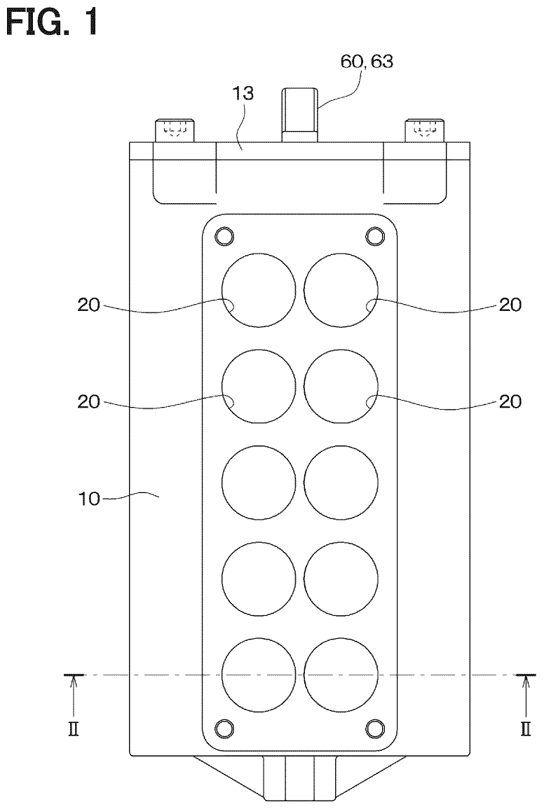

First of all, a structure of the rotary multi-way valve of the first embodiment will be described. As shown in FIGS. 1 to 5A, the rotary multi-way valve includes: a housing 10; a plurality of ports 20; at least one split rotor 30; a plurality of grooves 40 and a plurality of cutouts 50 which serve as a plurality of communication passages; a shaft 60, a plurality of limiters 70; and an urging member 80.

As shown in FIGS. 1, 4A, and 5A, the housing 10 is shaped in a bottomed tubular form and has a bottom portion 11 and a tubular portion 12, and the tubular portion 12 extends in a tubular form from the bottom portion 11. A lid member 13 is fixed in a liquid-tight manner to a portion of the tubular portion 12 of the housing 10 opposite to the bottom portion 11. The housing 10 has a housing hole 14 that is a hole shaped in cylindrical form in the housing 10. In the following description, a direction in which a central axis CL of the housing hole 14 extends, will be referred to an axial direction, and a radial direction in a cross-section perpendicular to the central axis CL of the housing hole 14 will be referred to as a radial direction. Furthermore, a circumferential direction in the cross-section perpendicular to the central axis CL of the housing hole 14 will be referred to as a circumferential direction.

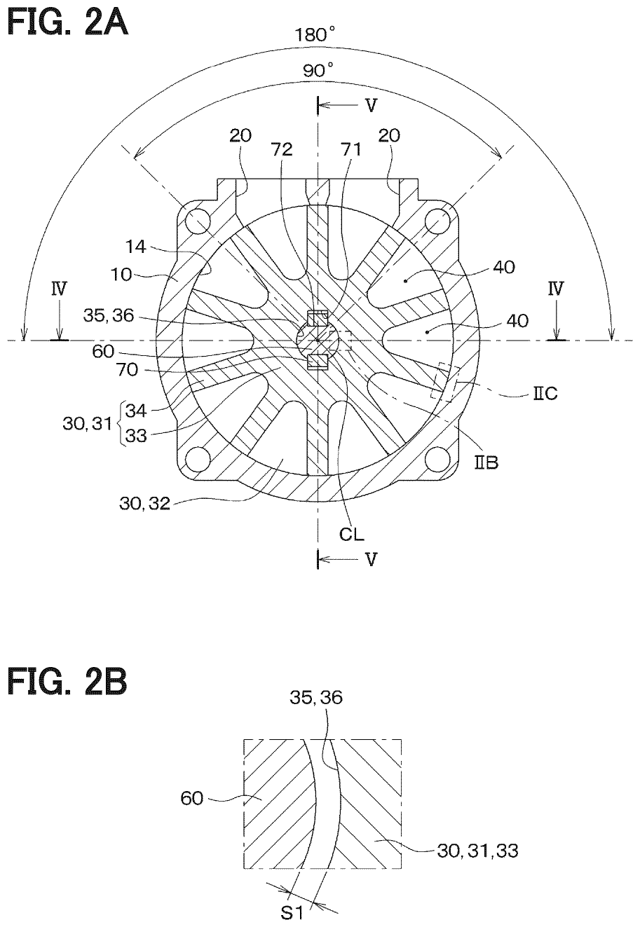

As shown in FIGS. 1 to 3A, the plurality of ports 20 are flow passage openings that extend through an outer wall surface and an inner wall surface of the housing 10. The plurality of ports 20 can be arranged at any positions in the axial direction, the circumferential direction and the radial direction at the housing 10. Additionally, the number of the plurality of ports 20 can also be set arbitrarily. In the first embodiment, for example, the number of the ports 20 is ten, and these ten ports 20 are arranged such that two of the ports 20 are arranged in the circumferential direction in each of five tiers arranged in the axial direction. As shown in FIG. 2A, in the first embodiment, the plurality of ports 20 are located within a predetermined angular range which is equal to or smaller than 180 degrees (specifically, equal to or smaller than 90 degrees) around the central axis CL of the housing hole 14, as viewed in a cross-section perpendicular to the central axis CL.

A length of the housing 10 becomes larger in the axial direction as the number of tiers of the ports 20 (i.e., the number of the ports 20 in the axial direction) increases, resulting in a drawback where the cylindricity tolerance of the housing 10 becomes larger.

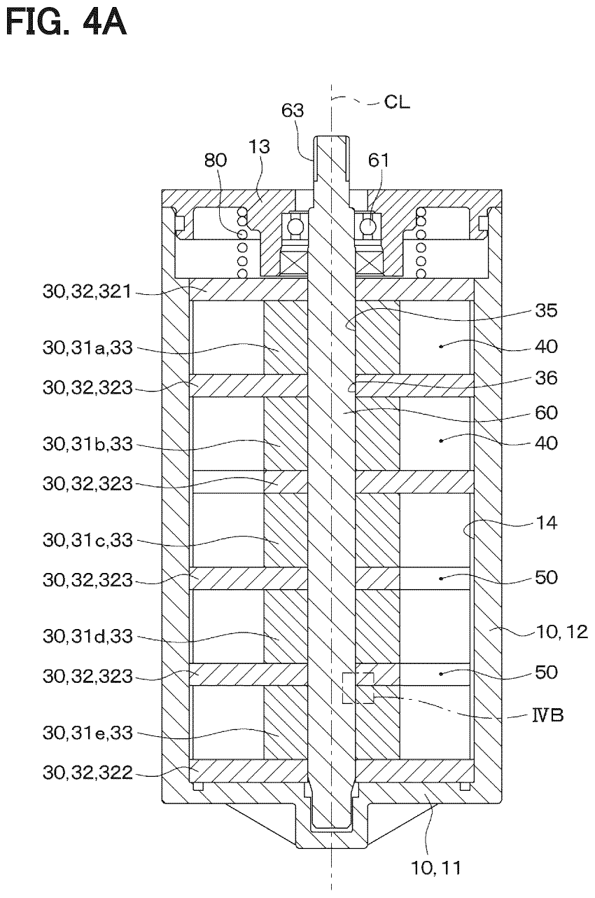

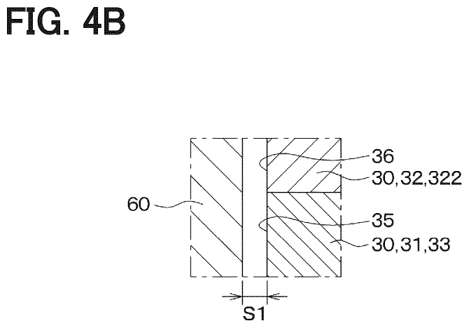

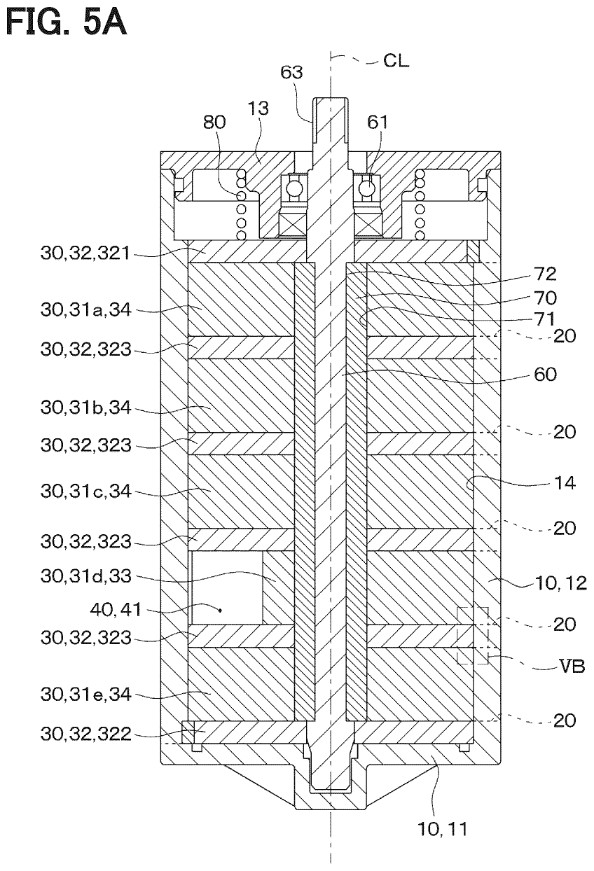

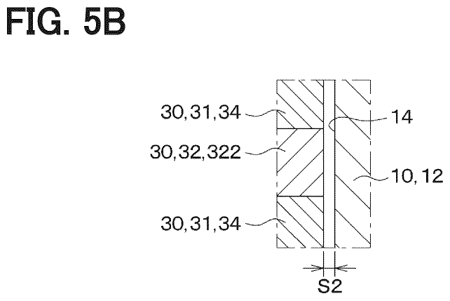

As shown in FIGS. 4A to 7, the split rotors 30 are stacked in the axial direction at the inside of the housing hole 14. The split rotors 30 are rotatable relative to the housing 10. As shown in FIGS. 2C and 5B, a minute gap S2 is formed between the split rotors 30 and an inner wall of the housing hole 14, forming a clearance seal structure. The clearance seal structure is a structure that reduces the gap between the inner wall of the housing hole 14 and the split rotors 30 to limit leakage of a fluid between the flow passages at the inside of the valve. The minute gap S2 is set based on factors such as the permissible amount of leakage of the fluid for the product (i.e., the rotary multi-way valve used in the predetermined thermal distribution system). In the first embodiment, the minute gap S2 is set to, for example, several tens of micrometers.

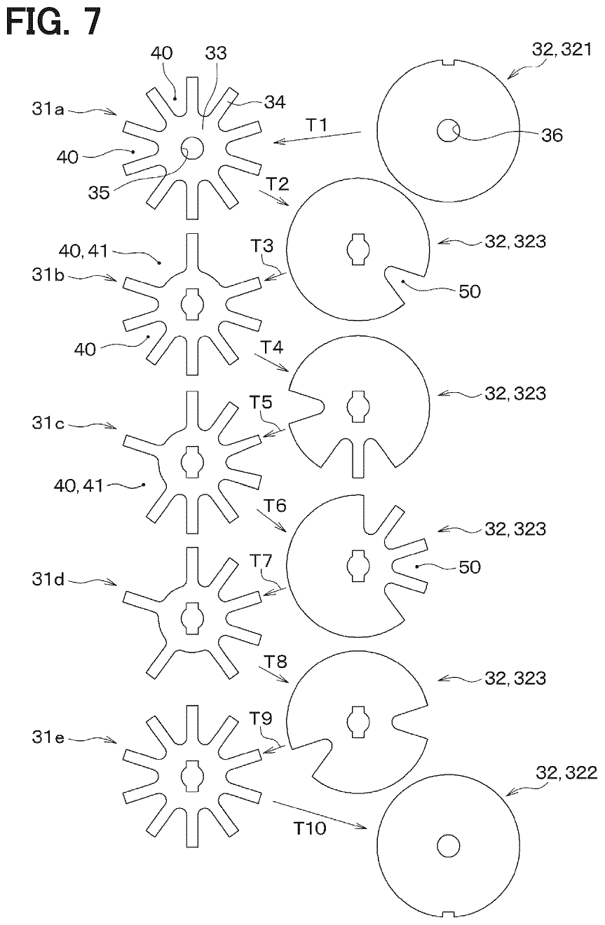

In the first embodiment, the plurality of split rotors 30 include a plurality of blocks 31 and a plurality of plates 32. The blocks 31 are arranged in the axial direction in the housing hole 14. Each of the plates 32 is arranged between corresponding adjacent two of the blocks 31. That is, the blocks 31 and the plates 32 are alternately arranged in the axial direction at the inside of the housing hole 14. In the example of the first embodiment shown in FIG. 7, a positioning order of the blocks 31 and the plates 32 inside the housing hole 14 is indicated by arrows T1-T10 starting from the lid member 13 side.

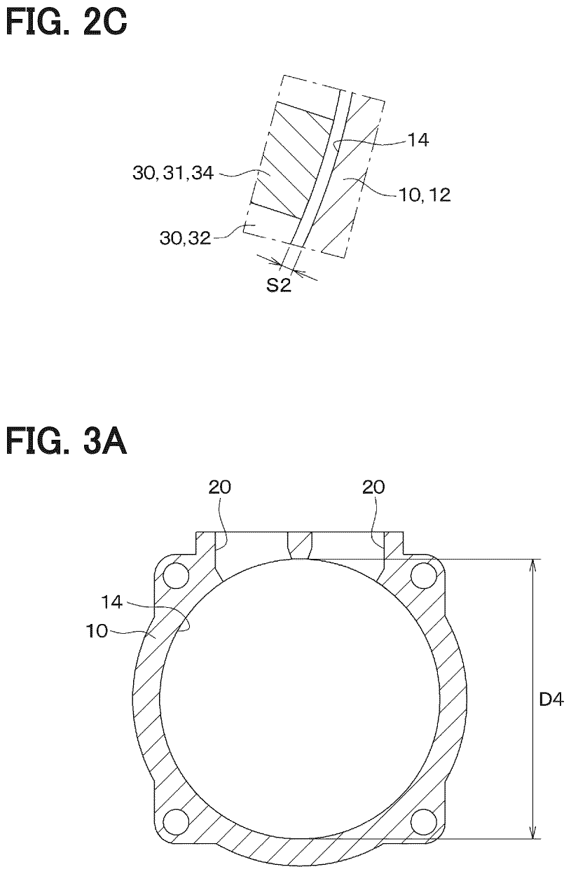

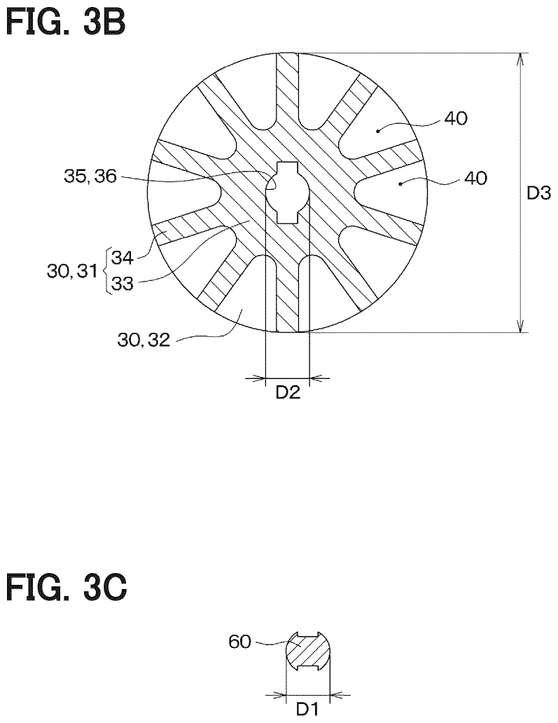

As shown in FIGS. 2A and 3B, each of the blocks 31 includes: a center portion 33; and a plurality of wall portions 34 which extend radially outward from the center portion 33. An insertion through-hole 35, through which the shaft 60 is inserted, is formed through the center portion 33 of each of the blocks 31. A groove 40, which serves as the communication passage, is formed between each circumferentially adjacent two of the wall portions 34 of each of the blocks 31. In the following description, for convenience, the five blocks 31 shown in FIGS. 4A to 7 may be referred to as a first block 31a, a second block 31b, a third block 31c, a fourth block 31d and a fifth block 31e in this order from the top of the drawing.

Similar to the blocks 31, an insertion through-hole 36, through which the shaft 60 is inserted, is formed through a center of each of the plates 32. Each of two opposite plates 32 respectively placed on one axial end and the other axial end among the plurality of plates 32, is a stationary plate, rotation of which relative to the housing 10 is restricted. In the following description, for convenience, the stationary plate positioned on the lid member 13 side will be referred to as a first stationary plate 321, and the stationary plate positioned on the bottom portion 11 side will be referred to as a second stationary plate 322. A seal member (not shown) is installed between the bottom portion 11 of the housing 10 and the second stationary plate 322.

The remaining plates 32, which are placed between the first stationary plate 321 and the second stationary plate 322, are rotatable plates 323 which are rotatable relative to the housing 10. Each of the rotatable plates 323 has one or more cutouts 50 each of which is cut inward from an outer peripheral edge of the rotatable plate 323 toward the center of the rotatable plate 323. The shape of each cutout 50 is not limited to the aforementioned form and may, for example, be a hole that extends through the rotatable plate 323 in a plate thickness direction of the rotatable plate 323.

The grooves 40 and the cutouts 50, which serve as the communication passages, of the split rotors 30 are configured to switch between a communicating state and a blocking state between a predetermined one of the ports 20 and another one of the ports 20. Specifically, the groove(s) 40 is formed in at least one of the plurality of blocks 31 and is configured to switch between the communicating state and the blocking state between the predetermined one of the plurality of ports 20 and the other one of the plurality of ports 20. As shown in FIG. 7, in the first embodiment, the grooves 40 are provided in all of the blocks 31, each of which has an arbitrary number of the grooves 40. Additionally, in the second block 31b, the third block 31c and the fourth block 31d, some of the wall portions 34 are positioned farther apart from each other in the circumferential direction, resulting in grooves 40 that are larger in the circumferential direction. In the following description, the grooves 40, which are formed larger in the circumferential direction, will be referred to as circumferential communication grooves 41. When the circumferential communication groove 41 spans adjacent two or more of the ports 20, which are adjacent in the circumferential direction of the housing 10, these adjacent ports 20 are communicated with each other thorough the circumferential communication groove 41.

The cutout(s) 50 is formed in at least one of the plurality of plates 32 and is configured to communicate between the groove 40 of a predetermined one of the plurality of blocks 31 and the groove 40 of another one of the plurality of blocks 31, which are located on one side and another side of the at least one of the plurality of plates 32 in the axial direction. In the first embodiment, each of the plurality of rotatable plates 323 has an arbitrary number of the cutout(s) 50.

As shown in FIGS. 4A and 5A, one end portion of the shaft 60 in the axial direction is rotatably supported by a bearing 61 installed to the lid member 13, and the other end portion of the shaft 60 in the axial direction is rotatably supported by the bottom portion 11 of the housing 10. The one end portion of the shaft 60 projects outward beyond the lid member 13. The shaft 60 is rotated around the central axis CL when a projecting portion 63 of the shaft 60, which projects outward from the lid member 13, receives torque from an actuator (not shown).

As shown in FIGS. 2A and 5A, the limiters 70 restrict relative rotation among the rotatable plates 323, the blocks 31 and the shaft 60. A radially outer portion of each of the limiters 70 is fitted into a corresponding one of a plurality of fitting grooves 71 each of which is formed in a corresponding one of the rotatable plates 323 and the blocks 31, and a radially inner portion of each of the limiters 70 is fitted into a corresponding one of two fitting grooves 72 each of which are formed in the shaft 60. The limiters 70 transmit the rotation of the shaft 60 to the rotatable plates 323 and the blocks 31 of the split rotors 30. Therefore, when the shaft 60 is rotated around the central axis CL, the rotatable plates 323 and the blocks 31 are also rotated accordingly. The limiters 70 do not restrict the axial movement of the rotatable plates 323 and the blocks 31 relative to the shaft 60. Additionally, since a radial size of each of the limiters 70 is smaller than a radial size of the corresponding fitting grooves 71, 72 into which the limiter 70 is fitted, minute radial movement of the rotatable plates 323 and the blocks 31 relative to the shaft 60 is permitted.

As shown in FIGS. 4A and 5A, the urging member 80, which is placed between the lid member 13 and the first stationary plate 321, is, for example, a compression coil spring. One end portion of the urging member 80 is anchored to the lid member 13, and the other end portion of the urging member 80 is anchored to the first stationary plate 321. The urging member 80 axially applies a load to the first stationary plate 321 toward the bottom portion 11. As described above, the minute gap S2 is formed between the split rotors 30 and the inner wall of the housing hole 14. Therefore, the load, which is applied by the urging member 80 to the first stationary plate 321, is hardly lost by, for example, friction between the inner wall of the housing hole 14 and the split rotors 30. Therefore, the urging member 80 can urge the first stationary plate 321, the rotatable plates 323 and the blocks 31 toward the second stationary plate 322 while maintaining almost the same urging force from the one axial side to the other axial side.

Here, as shown in FIGS. 3B and 3C, a difference between an outer diameter D1 of the shaft 60 and an inner diameter D2 of each of the insertion through-holes 35, 36 is set to be equal to or larger than a difference between an outer diameter D3 of a virtual circle, which circumferentially extends and connects radial outer edges of the split rotor 30, and an inner diameter D4 of the housing hole 14. The outer diameter D3 of the virtual circle, which circumferentially extends and connects the radially outer edges of the split rotor 30, refers to either the outer diameter D3 of the virtual circle, which circumferentially extends and connects the radially outer edges of the block 31, or the outer diameter D3 of the virtual circle, which circumferentially extends and connects the radially outer edges of the plate 32. Therefore, in a state where the central axis CL of the shaft 60 coincides with the central axis CL of the split rotors 30, a gap S1 between the outer wall of the shaft 60 and an inner wall of each insertion through-hole 35, 36 is equal to or larger than the gap S2 between the outer wall of each split rotor 30 and the inner wall of the housing hole 14. The gap S1 between the outer wall of the shaft 60 and the inner wall of the insertion through-hole 35, 36 is shown in FIGS. 2B and 4B, and the gap S2 between the outer wall of the split rotor 30 and the inner wall of the housing hole 14 is shown in FIGS. 2C and 5B. Therefore, minute movement of the split rotors 30 in the radial direction is enabled. As a result, even when the cylindricity tolerance of the split rotors 30 and the cylindricity tolerance of the housing 10 are relatively large, each of the split rotors 30 can self-align by conforming to the inner wall of the housing hole 14. Therefore, this rotary multi-way valve can relax the cylindricity tolerance of the split rotors 30 and the cylindricity tolerance of the housing 10 while minimizing leakage of the fluid between the flow passages at the inside of the valve.

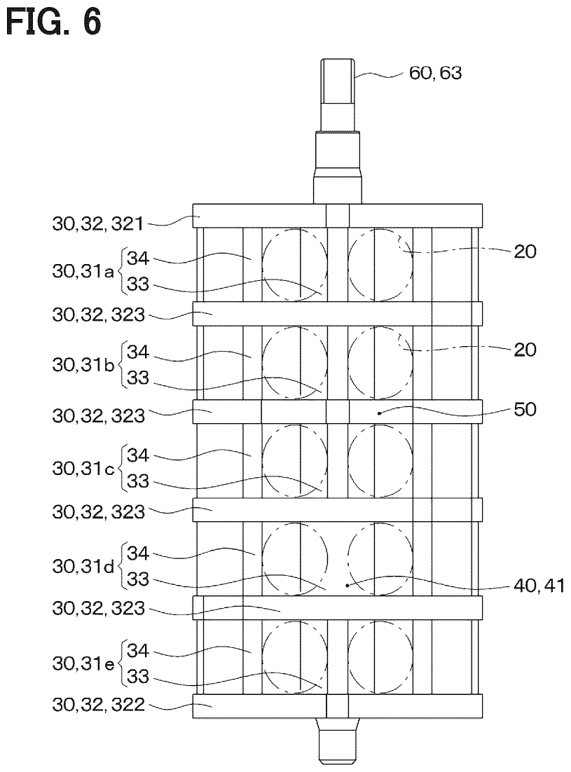

Next, the operation of the rotary multi-way valve will be explained with reference to FIGS. 6 to 8.

FIG. 6 is a side view showing an assembled state where the split rotors 30 and the shaft 60 are assembled together. In FIG. 6, a position of each of the ports 20 of the housing 10 is indicated by a dot-dash line in a state where the split rotors 30 and the shaft 60 are rotated to a predetermined position relative to the housing 10.

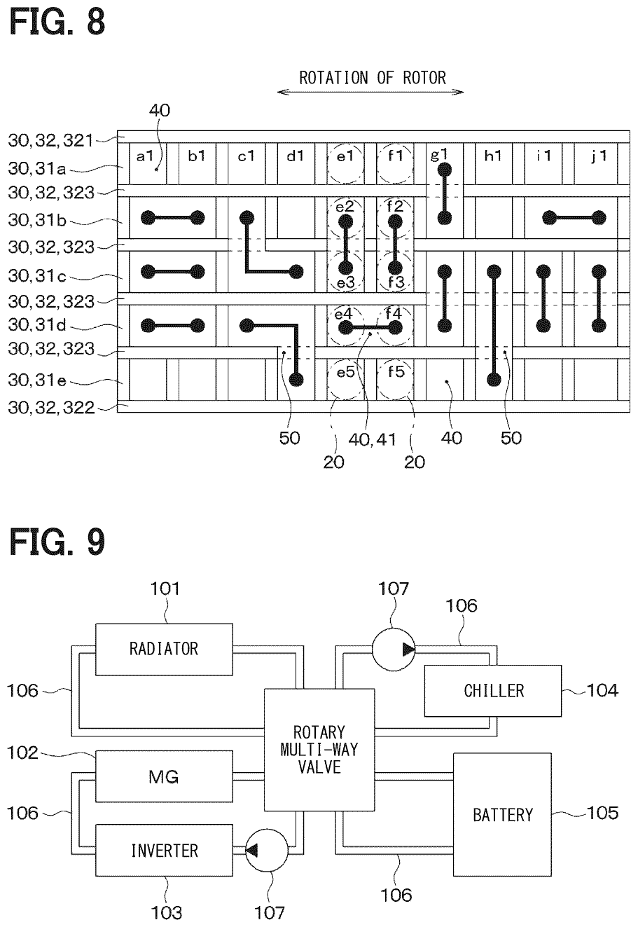

Furthermore, FIG. 8 is an unfolded view showing the split rotors 30, as viewed from a radially outer side in a state where the split rotors 30 are unfolded in the circumferential direction. In FIG. 8, for the convenience of explanation, the grooves 40 of the first block 31a are labeled a1-j1. Additionally, among the grooves 40 of the second to fifth blocks 31b-31e, the grooves 40, which are aligned with e1 in the axial direction, are labeled e2-e5, and the grooves 40, which are aligned with f1 in the axial direction, are labeled f2-f5. It should be noted that e4 and f4 constitute a single circumferential communication groove 41. Furthermore, in FIG. 8, each of locations where the corresponding grooves 40 communicate each other, is indicated by a symbol connecting two black dots with a bold line. The circumferential communication grooves 41 are also indicated using the same symbols. In FIG. 8, the positions of the ports 20 of the housing 10 are also indicated by a dot-dash line in a state where the split rotors 30 and the shaft 60 are rotated to the predetermined position relative to the housing 10. By rotating the split rotors 30 and the shaft 60 relative to the housing 10, the relative positional relationship between the split rotors 30 and the ports 20 changes in the left-right direction in FIG. 8.

In the state shown in FIG. 8, the grooves 40 labeled e2 and e3 are communicated with each other, and the grooves 40 labeled f2 and f3 are communicated with each other. Additionally, the grooves 40 labeled e4 and f4 (i.e., the circumferential communication groove 41) are communicated with each other. On the other hand, the grooves 40 labeled e1, f1, e5 and f5 are not connected to any other grooves. Therefore, in this state, the ports 20, which correspond to the grooves 40 communicated with each other, allow the flow of the fluid therebetween, and the ports 20, which correspond to the grooves 40 not connected to any other grooves, block the flow of the fluid therethrough. When the split rotors 30 and the shaft 60 are rotated relative to the housing 10, the relative positional relationship between the split rotors 30 and the ports 20 changes. Therefore, the communicating state and the blocking state of the corresponding ports 20 are switched. As discussed above, the rotary multi-way valve can switch between the communicating state and the blocking state of the fluid flow passages, enabling the realization of various flow patterns.

The rotary multi-way valve of the first embodiment described above implements the following actions and advantages.

(1) In the first embodiment, the rotary multi-way valve includes the split rotors 30 placed in the inside of the housing hole 14. The minute gap S2 is formed between the split rotors 30 and the inner wall of the housing hole 14, enabling the minute movement of the split rotors 30 in the radial direction.

Accordingly, in the rotary multi-way valve having the clearance seal structure, each of the split rotors 30 can self-align by conforming to the inner wall of the housing hole 14. Therefore, this rotary multi-way valve can relax the cylindricity tolerance of the split rotors 30 and the cylindricity tolerance of the housing 10 while minimizing the leakage of the fluid between the flow passages in the inside of the valve. Additionally, due to the clearance seal structure, the minute gap S2 is formed between the split rotors 30 and the inner wall of the housing hole 14, and thereby reducing the sliding friction between the inner wall of the housing hole 14 and the split rotors 30. Therefore, the rotary multi-way valve can reduce the drive torque, which is required to rotate the split rotors 30 and the shaft 60 around the central axis CL.

(2) In the first embodiment, the difference between the outer diameter D1 of the shaft 60 and the inner diameter D2 of each of the insertion through-holes 35, 36 is set to be equal to or larger than the difference between the outer diameter D3 of the virtual circle, which circumferentially extends and connects the radial outer edges of the split rotor 30, and the inner diameter D4 of the housing hole 14. It should be noted that the differences are compared in terms of absolute value.

Accordingly, a size of the gap S1 between the outer wall of the shaft 60 and the inner wall of the insertion through-hole 35, 36 is equal to or larger than that of the gap S2 between the outer edge of the split rotor 30 and the inner wall of the housing hole 14. Therefore, at the time of rotating the split rotors 30 together with the shaft 60 around the central axis CL, when the outer edges of the split rotors 30 come into contact with the inner wall of the housing hole 14, the split rotors 30 can self-align to a position where split rotors 30 do not interfere with the inner wall of the housing hole 14.

(3) In the first embodiment, the plurality of split rotors 30 include the plurality of blocks 31 arranged in the axial direction in the housing hole 14 and the plurality of plates 32 each of which is positioned between the corresponding two of the blocks 31. The at least one groove 40 is formed in the at least one of the plurality of blocks 31, and the at least one cutout 50 is formed in the at least one of the plurality of plates 32.

Accordingly, the groove(s) 40 formed in the block(s) 31 (specifically, the circumferential communication groove 41) enables the predetermined port 20 to communicate with the other port 20 in the circumferential direction or the radial direction of the housing hole 14. Additionally, the cutout(s) 50 formed in the plate(s) 32 enables the groove 40 of the predetermined block 31 to communicate with the groove 40 of the other block 31 in the axial direction in the housing hole 14. Therefore, by combining the grooves 40 of the plurality of blocks 31 with the cutouts 50 of the plurality of plates 32, any desired communication pattern can be achieved.

(4) On the other hand, in a case where each of the plates 32 does not have the cutout 50, and a significant pressure difference occurs between the front and back surfaces of any one of the plates 32, this plate 32 and the adjacent block 31, which is adjacent to this plate 32, may be separated from each other, potentially causing leakage at the flow passage that is intended to be sealed. The above-described case, in which the plate 32 does not have the cutout 50, and the significant pressure difference occurs between the front and back surfaces of the plate 32, may occur, for example, in the state shown in FIG. 8, where the fluid having the low pressure flows through e3 and f3, and the fluid having the high pressure flows through e4 and f4.

In contrast, in the first embodiment, the urging member 80 applies the load to the first stationary plate 321 to urge the first stationary plate 321, the rotatable plates 323, the second stationary plate 322 and the blocks 31 from the one side toward the other side in the axial direction in the housing hole 14.

Accordingly, even when the pressure difference of the fluid flowing inside the housing 10 becomes large, it is possible to limit the blocks 31 and the plates 32 from separating in the axial direction in the housing hole 14. As a result, the rotary multi-way valve can limit the leakage of the fluid between the flow passages at the inside of the housing 10. Additionally, since the first stationary plate 321, to which the load is applied by the urging member 80, is restricted from rotating relative to the housing 10, it is possible to limit wear between the urging member 80 and the first stationary plate 321. Therefore, the rotary multi-way valve can ensure reliability.

By the way, in the structure like the previously proposed rotary valve described above, where a sealing member provided on the outer periphery of the rotor slidably contacts the inner wall of the housing hole 14 with a predetermined surface pressure, the frictional force accumulates according to the restoring force of the rubber's elastic deformation and the friction coefficient over the length of the sealing member. Therefore, when the number of ports 20 in the multi-way valve increases in the axial direction, the urging force of the urging member 80 must be increased, resulting in the need for a large drive torque to rotate the rotor.

In contrast, since the rotary multi-way valve of the first embodiment uses the clearance seal structure, the urging force of the urging member 80 may remain theoretically constant regardless of the number of tiers of the ports 20 in the multi-way valve. In this respect as well, the clearance seal structure is highly compatible with the split rotor structure, enabling a reduction in the drive torque required for the rotation of the split rotors 30 and the shaft 60.

(5) In the first embodiment, the plurality of ports 20 are located within the predetermined angular range which is equal to or smaller than 180 degrees around the central axis CL of the housing hole 14, as viewed in the cross-section perpendicular to the central axis CL.

Accordingly, for example, at the time of installing the rotary multi-way valve in the vehicle, it becomes possible to simplify the routing of the vehicle-side pipe line and improve the work efficiency of assembling the ports 20 of the rotary multi-way valve with the vehicle-side pipe line.

Additionally, this structure is effective when modularizing a thermal management device, such as a pump and/or a chiller, together with the rotary multi-way valve. That is, since the ports 20 of the rotary multi-way valve are collectively arranged on the one side of the rotary multi-way valve, the rotary multi-way valve can be connected without using a pipe line by coupling the surface of the rotary multi-way valve where the ports 20 are located to the surface of the thermal management device that has openings for the fluid flow passages.

### Second Embodiment

Next, the second embodiment will be described. According to the second embodiment, the rotary multi-way valve described in the first embodiment is applied to a thermal distribution system.

As shown in FIG. 9, the rotary multi-way valve can be applied to the thermal distribution system used in an electric vehicle. The thermal distribution system is a system that performs thermal management by distributing the hot/cold water in various patterns, depending on the situation, to devices requiring heat absorption or heat release, such as an electric drive device, an air conditioning device and/or a battery 105 of the electric vehicle. The hot/cold water is, for example, LLC (long-life coolant). Here, LLC stands for Long Life Coolant. In FIG. 9, the thermal distribution system includes devices such as a radiator 101, a motor generator 102, an inverter 103, a chiller 104 and the battery 105. The motor generator 102 is an example of the electric drive device, and the inverter 103 is another example of the electric drive device, and the chiller 104 is an example of the air conditioning device. These devices are connected to the rotary multi-way valve via a pipe line 106, which serves as a fluid flow passage. A fluid pump 107 and a liquid reservoir (not shown) are installed along the pipe line, which serves as the fluid flow passage.

The rotary multi-way valve allows the circulation of the hot/cold water to the required devices at the required timing by rotating the shaft 60 and the split rotors 30 around the central axis CL relative to the housing 10 and setting the shaft 60 and the split rotors 30 to a predetermined position. FIG. 9 shows only a part of the thermal distribution system. In reality, more pipe lines 106 and devices requiring heat absorption or the heat release are connected to the rotary multi-way valve.

In the thermal management systems of the electric vehicles, each vehicle manufacturer has various system configurations, requiring a wide variety of communication patterns for the multi-way valve to match those configurations. In contrast, in the second embodiment, as shown in FIGS. 7 and 8, any communication pattern can be realized by combining various patterns of the plates 32 and blocks 31. Specifically, by preparing a plurality of patterns of the cutouts 50 provided on the plates 32 and grooves 40 provided on the blocks 31, and combining these patterns, it is possible to arbitrarily configure the communication pattern as needed. This allows for the easy realization of variations tailored to specific requirements.

The thermal distribution system of the second embodiment described above enables the downsizing of the actuator that drives the shaft 60 of the rotary multi-way valve and the reduction of the electric power required for the operation of the actuator by incorporating the rotary multi-way valve of the first embodiment or the later-described embodiments.

Similar to the first embodiment, the rotary multi-way valve of the second embodiment enables a change in the communication pattern of the plurality of ports 20 by changing at least one of the position and the shape of at least one of: at least one of the plurality of blocks 31, in each of which the location of one or more of the grooves 40 differs from the location of one or more of the grooves 40 in another one or more of the plurality of blocks 31; and at least one of the plurality of plates 32, in each of which the location of one or more of the cutout(s) 50 differs from the location of one or more of the cutout(s) 50 of another one or more of the plurality of plates 32.

Accordingly, the rotary multi-way valve can accommodate various thermal distribution systems with, for example, different fluid flow passage configurations.

### Third Embodiment

The third embodiment will be described. The rotary multi-way valve of the third embodiment is a modification of the rotary multi-way valve described in the first embodiment, with some changes made to the configuration of the housing 10.

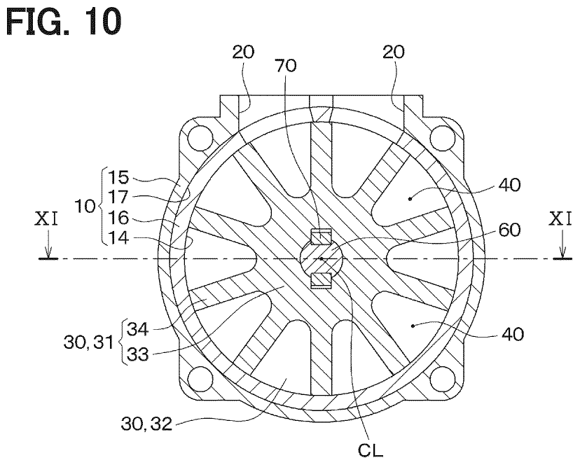

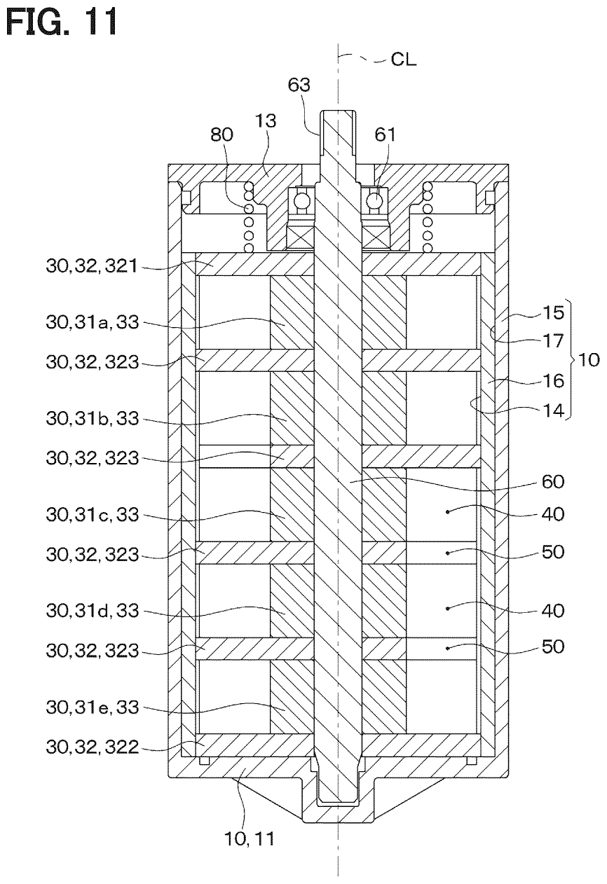

As shown in FIGS. 10 and 11, the housing 10 of the rotary multi-way valve in the third embodiment includes an outer housing 15 and a cylinder 16. The outer housing 15 has a receiving hole 17 which receives the cylinder 16, and the outer housing 15 forms an outer shell of the housing 10. The cylinder 16, which is received in the receiving hole 17 of the outer housing 15, has the housing hole 14 shaped in the cylindrical form. Various methods, such as press-fitting, can be employed to join the outer housing 15 and the cylinder 16. Additionally, a sealing member (not shown) may be inserted between the outer housing 15 and the cylinder 16 to ensure the sealing of the connection.

In the rotary multi-way valve of the third embodiment described above, the housing 10 includes the outer housing 15 and the cylinder 16. Accordingly, since the cylinder 16, which requires high dimensional accuracy for the inner diameter and precision in cylindricity of the housing hole 14, is formed as a separate component from the outer housing 15, the machining accuracy of the cylinder 16 can be improved, and the machining process of the cylinder 16 can be performed more easily.

Additionally, in the rotary multi-way valve of the third embodiment, it is preferable that the cylinder 16 and the split rotors 30 are formed from a common material. As a result, in a case where the cylinder 16 and the split rotors 30 thermally expand due to temperature changes in the working fluid flowing through the rotary multi-way valve, the cylinder 16 and the split rotors 30 will expand at the same linear expansion coefficient if they are made of the common material. Therefore, it is possible to limit an increase or decrease in a size of a gap between the inner wall of the housing hole 14 and the split rotors 30.

### Fourth Embodiment

Next, the fourth embodiment will be described. The rotary multi-way valve of the fourth embodiment is a modification of the rotary multi-way valve described in the first embodiment, with some changes made to the structure of the housing 10.

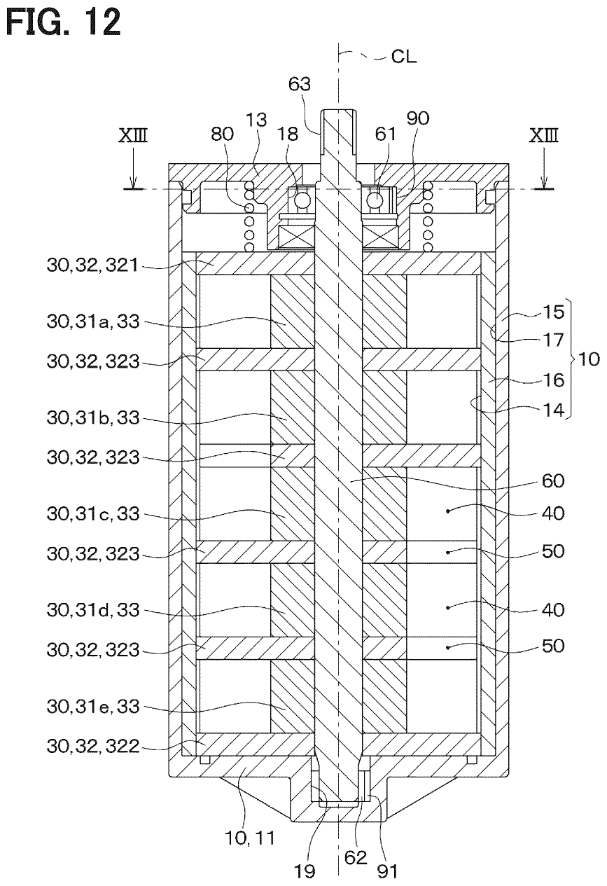

As shown in FIG. 12, the one end portion of the shaft 60 is rotatably supported by the first bearing 61 installed to the lid member 13, and the other end portion of the shaft 60 is rotatably supported by a second bearing 62 installed to the bottom portion 11 of the housing 10. The first bearing 61 is, for example, a ball bearing installed in a bearing hole 18 formed in the lid member 13, while the second bearing 62 is, for example, a sleeve bearing installed in a bearing hole 19 formed in the bottom portion 11 of the housing 10.

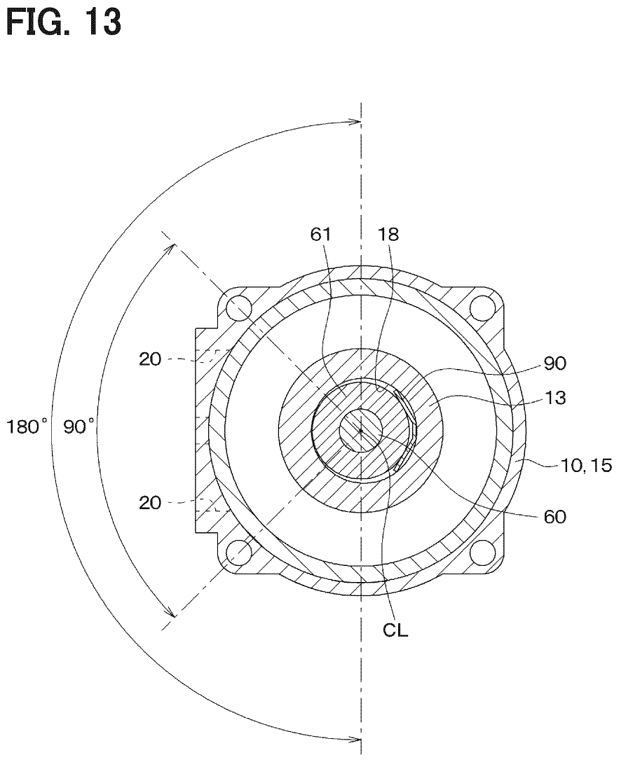

As shown in FIG. 13, the plurality of ports 20 of the rotary multi-way valve in the fourth embodiment are also located, like in the first embodiment, within the predetermined angular range which is equal to or smaller than 180 degrees (specifically, equal to or smaller than 90 degrees) around the central axis CL of the housing hole 14, as viewed in the cross-section perpendicular to the central axis CL.

As shown in FIGS. 12 and 13, the rotary multi-way valve of the fourth embodiment includes a plurality (two in this instance) of urging members 90, 91 that urge the shaft 60 toward the side of the housing 10 where the plurality of ports 20 are located. The urging members 90, 91 are made of, for example, two leaf springs, respectively. The urging member 90 is positioned between an inner wall of the bearing hole 18 formed in the lid member 13 and the first bearing 61. The other urging member 91 is positioned between an inner wall of the bearing hole 19 formed in the bottom portion 11 of the housing 10 and the second bearing 62. These two urging members 90, 91 urge the first bearing 61 and the second bearing 62, respectively, toward the side where the plurality of ports 20 are located. This allows the rotary multi-way valve of the fourth embodiment to reduce the gap between the split rotors 30 and the vicinity of the portion of the inner wall of the housing hole 14 where the ports 20 are located. Therefore, the cylindricity tolerances of the split rotors 30 and the housing 10 can be further relaxed, and the leakage of the fluid between the flow passages in the inside of the valve can be further minimized. It should be noted that an opposite portion of the inner wall of the housing hole 14, which is opposite to the plurality of ports 20, is not used as a flow passage, so an increase in the gap at that location is not an issue.

### Fifth Embodiment

Next, the fifth embodiment will be described. The rotary multi-way valve of the fifth embodiment is a modification of the rotary multi-way valve described in the first, third and fourth embodiments, with some changes made to the structure of the split rotors 30.

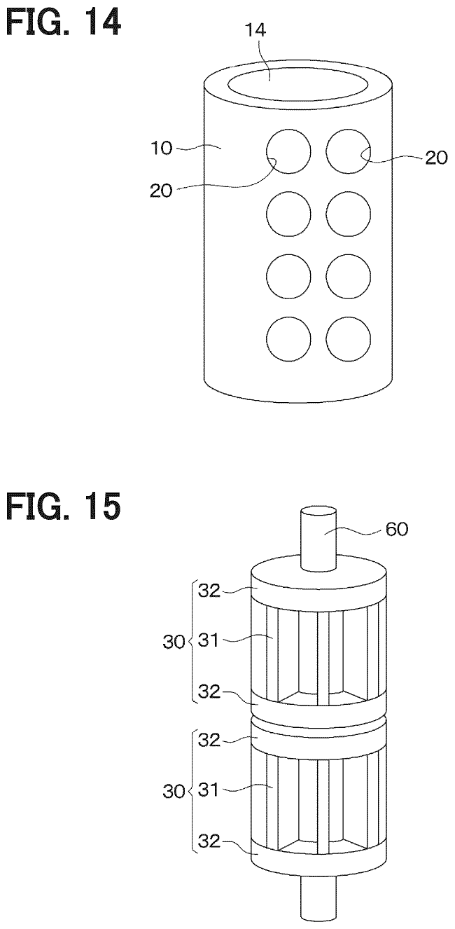

In the description of the fifth embodiment, FIG. 14 shows the housing 10 of the rotary multi-way valve, and FIG. 15 shows the assembled state of the split rotors 30 and the shaft 60. As shown in FIG. 15, the split rotors 30 of the rotary multi-way valve in the fifth embodiment are constructed such that the block 31 and plates 32 of each split rotor 30 are formed integrally in one-piece. The split rotors 30 are arranged in the axial direction in the housing hole 14. The number of split rotors 30 is not limited to two shown in FIG. 15. For example, the number of split rotors 30 may be one, or three or more.

The rotary multi-way valve of the fifth embodiment described above can achieve the same actions and advantages as those of the first, third and fourth embodiments.

### Other Embodiments

(1) In each of the embodiments described above, the split rotors 30 have been described as including both the blocks 31 and the plates 32. However, the present disclosure is not limited to such a structure. For example, the split rotors 30 may be formed solely from the blocks or solely from the plates 32.

(2) In each of the embodiments described above, the rotary multi-way valve has no sealing member between the inner wall of the housing hole 14 and the split rotors 30. However, the present disclosure is not limited to such a structure. For example, a sealing member may be provided partially, as needed between the inner wall of the housing hole 14 and the split rotors 30.

(3) In each of the embodiments described above, the rotary multi-way valve has the plurality of ports 20 located within the predetermined angular range which is equal to or smaller than 180 degrees around the central axis CL of the housing hole in the cross-sectional view perpendicular to the central axis CL. However, the present disclosure is not limited to such a structure. For example, one or more of the ports 20 may also be arranged outside the predetermined angular range which is equal to or smaller than 180 degrees.

(4) In each of the embodiments described above, the rotary multi-way valve was described as being used in the electric vehicle. However, the present disclosure is not limited to such an application. The rotary multi-way valve may also be used in other applications which are other than the electric vehicles.

(5) In each of the embodiments described above, the urging member 80 is formed by the compression coil spring. However, the present disclosure is not limited to this. That is, the urging member 80 may also be formed by a member having an elastic force, such as rubber, or the rotary multi-way valve may not have the urging member.

(6) In the first embodiment described above, the rotary multi-way valve can realize that the number of the ports is ten (10), and the number of the modes is ten (10). However, the present disclosure is not limited to this setting. That is, the number of the ports and the number of the modes may be set arbitrarily.

The present disclosure is not limited to the embodiments described above, and the embodiments described above may be appropriately modified. Further, the embodiments described above are not unrelated to each other and can be appropriately combined unless the combination is clearly impossible. Needless to say, in each of the embodiments described above, the elements of the embodiment are not necessarily essential except when it is clearly indicated that they are essential and when they are clearly considered to be essential in principle. In each of the embodiments described above, when a numerical value such as the number, numerical value, amount, range or the like of the constituent elements of the embodiment is mentioned, the present disclosure should not be limited to such a numerical value unless it is clearly stated that it is essential and/or it is required in principle. In each of the embodiments described above, when the shape, the positional relationship or the like of the constituent elements of the embodiment are mentioned, the present disclosure should not be limited to the shape, the positional relationship or the like unless it is clearly stated that it is essential and/or it is required in principle.

### (Aspects of Present Disclosure)

The present disclosure described above can be understood as the following aspects, for example.

### (Aspect 1)

According to aspect 1, there is provided a rotary multi-way valve configured to switch between a communicating state and a blocking state of each of a plurality of fluid flow passages, the rotary multi-way valve comprising:
a housing that has a housing hole shaped in a cylindrical form;
a plurality of ports that are formed in the housing and are arranged in an axial direction, a circumferential direction or a radial direction of the housing hole and extend through an outer wall surface and an inner wall surface of the housing;
at least one split rotor that is arranged in the axial direction in the housing hole and is configured to rotate relative to the housing;
at least one communication passage that is formed in the at least one split rotor and is configured to switch between a communicating state and a blocking state between a predetermined one of the plurality of ports and another one of the plurality of ports; and
a shaft that is configured to rotate the at least one split rotor around a central axis of the housing hole, wherein:
a minute gap is formed between the at least one split rotor and an inner wall of the housing hole to enable minute movement of the at least one split rotor in the radial direction.

### (Aspect 2)

According to aspect 2, there is provided the rotary multi-way valve according to aspect 1, comprising a limiter that is configured to restrict relative rotation between the at least one split rotor and the shaft and to transmit rotation of the shaft to the at least one split rotor, wherein:
the at least one split rotor has an insertion through-hole through which the shaft is inserted; and
a difference between an outer diameter of the shaft and an inner diameter of the insertion through-hole is equal to or larger than a difference between an outer diameter of a virtual circle, which circumferentially extends and connects one or more radially outer edges of the at least one split rotor, and an inner diameter of the housing hole.

### (Aspect 3)

According to aspect 3, there is provided the rotary multi-way valve according to aspect 1 or 2, wherein:
the at least one split rotor is a plurality of split rotors that include:
   a plurality of blocks that are arranged in the axial direction in the housing hole; and
   a plurality of plates each of which is arranged between corresponding adjacent two of the plurality of blocks; and
the at least one communication passage includes:
   at least one groove that is formed in one or more of the plurality of blocks and is configured to switch between the communicating state and the blocking state between the predetermined one of the plurality of ports and the another one of the plurality of ports; and
   at least one cutout that is formed in one or more of the plurality of plates and is configured to communicate between the at least one groove of a predetermined one of the plurality of blocks and the at least one groove of another one of the plurality of blocks which are located on one side and another side of one of the one or more of the plurality of plates in the axial direction in the housing hole.

### (Aspect 4)

According to aspect 4, there is provided the rotary multi-way valve according to aspect 3, wherein the plurality of split rotors are configured to change a communication pattern of the plurality of ports by changing at least one of a position and a shape of at last one of:
at least one of the plurality of blocks, in each of which a location of the at least one groove differs from the location of the at least one groove in another one or more of the plurality of blocks; and
at least one of the plurality of plates, in each of which a location of the at least one cutout differs from the location of the at least one cutout in another one or more of the plurality of plates.

### (Aspect 5)

According to aspect 5, there is provided the rotary multi-way valve according to aspect 3 or 4, wherein:
the plurality of plates include:
   a stationary plate that is placed at one end or another end among the plurality of plates in the axial direction in the housing hole, wherein rotation of the stationary plate relative to the housing is restricted; and
   a rotatable plate that is placed between the one end and the another end among the plurality of plates in the axial direction in the housing hole, wherein the rotatable plate is rotatable relative to the housing; and
the rotary multi-way valve comprises an urging member that is configured to apply a load to the stationary plate to urge the stationary plate, the rotatable plate and the plurality of blocks from one side toward another side in the axial direction in the housing hole.

### (Aspect 6)

According to aspect 6, there is provided the rotary multi-way valve according to any one of aspects 1 to 5, wherein the housing includes:
a cylinder that has the housing hole; and
an outer housing that forms an outer shell of the housing and has a receiving hole that receives the cylinder.

### (Aspect 7)

According to aspect 7, there is provided the rotary multi-way valve according to aspect 6, wherein the cylinder and the at least one split rotor are made of a common material.

### (Aspect 8)

According to aspect 8, there is provided the rotary multi-way valve according to any one of aspects 1 to 7, wherein the plurality of ports are arranged within a predetermined angular range, which is equal to or smaller than 180 degrees around the central axis of the housing hole, as viewed in a cross-section perpendicular to the central axis of the housing hole.

### (Aspect 9)

According to aspect 9, there is provided the rotary multi-way valve according to aspect 8, comprising an urging member that is configured to urge the shaft against the housing toward a side where the plurality of ports are located.

### (Aspect 10)

According to aspect 10, there is provided a thermal distribution system for an electric vehicle, comprising:
the rotary multi-way valve of aspect 1;
a fluid flow passage that is connected to the plurality of ports of the rotary multi-way valve; and
a battery, an electric drive device or an air conditioning device which is connected midway along the fluid flow passage, wherein:
the thermal distribution system is configured to circulate hot water and cold water to one or more required devices at a required timing when the at least one split rotor and the shaft of the rotary multi-way valve are rotated around the central axis of the housing hole and are set to a predetermined position.

What is claimed is:

1. A rotary multi-way valve configured to switch between a communicating state and a blocking state of each of a plurality of fluid flow passages, the rotary multi-way valve comprising:
a housing that has a housing hole shaped in a cylindrical form;
a plurality of ports that are formed in the housing and are arranged in an axial direction, a circumferential direction or a radial direction of the housing hole and extend through an outer wall surface and an inner wall surface of the housing;
at least one split rotor that is arranged in the axial direction in the housing hole and is configured to rotate relative to the housing;
at least one communication passage that is formed in the at least one split rotor and is configured to switch between a communicating state and a blocking state between a predetermined one of the plurality of ports and another one of the plurality of ports; and
a shaft that is configured to rotate the at least one split rotor around a central axis of the housing hole, wherein:
a minute gap is formed between the at least one split rotor and an inner wall of the housing hole to enable minute movement of the at least one split rotor in the radial direction.

2. The rotary multi-way valve according to claim 1, comprising a limiter that is configured to restrict relative rotation between the at least one split rotor and the shaft and to transmit rotation of the shaft to the at least one split rotor, wherein:
the at least one split rotor has an insertion through-hole through which the shaft is inserted; and
a difference between an outer diameter of the shaft and an inner diameter of the insertion through-hole is equal to or larger than a difference between an outer diameter of a virtual circle, which circumferentially extends and connects one or more radially outer edges of the at least one split rotor, and an inner diameter of the housing hole.

3. The rotary multi-way valve according to claim 1, wherein:
the at least one split rotor is a plurality of split rotors that include:
a plurality of blocks that are arranged in the axial direction in the housing hole; and
a plurality of plates each of which is arranged between corresponding adjacent two of the plurality of blocks; and
the at least one communication passage includes:
at least one groove that is formed in one or more of the plurality of blocks and is configured to switch between the communicating state and the blocking state between the predetermined one of the plurality of ports and the another one of the plurality of ports; and
at least one cutout that is formed in one or more of the plurality of plates and is configured to communicate between the at least one groove of a predetermined one of the plurality of blocks and the at least one groove of another one of the plurality of blocks which are located on one side and another side of one of the one or more of the plurality of plates in the axial direction in the housing hole.

4. The rotary multi-way valve according to claim 3, wherein the plurality of split rotors are configured to change a communication pattern of the plurality of ports by changing at least one of a position and a shape of at last one of:
at least one of the plurality of blocks, in each of which a location of the at least one groove differs from the location of the at least one groove in another one or more of the plurality of blocks; and
at least one of the plurality of plates, in each of which a location of the at least one cutout differs from the location of the at least one cutout in another one or more of the plurality of plates.

5. The rotary multi-way valve according to claim 3, wherein:
the plurality of plates include:
a stationary plate that is placed at one end or another end among the plurality of plates in the axial direction in the housing hole, wherein rotation of the stationary plate relative to the housing is restricted; and
a rotatable plate that is placed between the one end and the another end among the plurality of plates in the axial direction in the housing hole, wherein the rotatable plate is rotatable relative to the housing; and
the rotary multi-way valve comprises an urging member that is configured to apply a load to the stationary plate to urge the stationary plate, the rotatable plate and the plurality of blocks from one side toward another side in the axial direction in the housing hole.

6. The rotary multi-way valve according to claim 1, wherein the housing includes:
a cylinder that has the housing hole; and
an outer housing that forms an outer shell of the housing and has a receiving hole that receives the cylinder.

7. The rotary multi-way valve according to claim 6, wherein the cylinder and the at least one split rotor are made of a common material.

8. The rotary multi-way valve according to claim 1, wherein the plurality of ports are arranged within a predetermined angular range, which is equal to or smaller than 180 degrees around the central axis of the housing hole, as viewed in a cross-section perpendicular to the central axis of the housing hole.

9. The rotary multi-way valve according to claim 8, comprising an urging member that is configured to urge the shaft against the housing toward a side where the plurality of ports are located.

10. A thermal distribution system for an electric vehicle, comprising:
the rotary multi-way valve of claim 1;
a fluid flow passage that is connected to the plurality of ports of the rotary multi-way valve; and
a battery, an electric drive device or an air conditioning device which is connected midway along the fluid flow passage, wherein:
the thermal distribution system is configured to circulate hot water and cold water to one or more required devices at a required timing when the at least one split rotor and the shaft of the rotary multi-way valve are rotated around the central axis of the housing hole and are set to a predetermined position.
